(19) United States
(12) Patent Application Publication
(10) Pub. No.: US 2013/0135430 A1
(43) Pub. Date: May 30, 2013

(54) METHOD FOR ADJUSTING MOVING DEPTHS OF VIDEO

(71) Applicants: Guang-Zhi Liu, Shanghai City (CN); Chun Wang, Shanghai City (CN); Jian-De Jiang, Shaanxi Province (CN); Guo-Qing Liu, Shanghai (CN)

(72) Inventors: Guang-Zhi Liu, Shanghai City (CN); Chun Wang, Shanghai City (CN); Jian-De Jiang, Shaanxi Province (CN); Guo-Qing Liu, Shanghai (CN)

(73) Assignee: NOVATEK MICROELECTRONICS CORP., Hsinchu (TW)

(21) Appl. No.: 13/455,130

(22) Filed: Apr. 25, 2012

(30) Foreign Application Priority Data
Nov. 24, 2011 (CN) 201110377977.1

(51) Int. Cl. H04N 13/00

(52) U.S. Cl. 348/42; 348/E09.037

(57) ABSTRACT

A method for adjusting moving depths for a video is provided, which is adapted for 2D to 3D conversion. The method includes receiving a plurality of frames at a plurality time points and calculating a plurality of local motion vectors and a global motion vector in each of the frames. The method also includes determining a first difference degree between the local motion vectors and the global motion vector in the frames. The method further includes determining a second difference degree between a current frame and the other frames of the frames. The method also includes calculating a gain value according to the first difference degree and the second difference degree. The method further includes adjusting original moving depths of the current frame according to the gain value. Accordingly, a phenomenon of depth inversion can be avoided or mitigated.

### CROSS-REFERENCE TO RELATED APPLICATION

This application claims the priority benefit of China application serial no. 201110377977.1, filed on Nov. 24, 2011. The entirety of the above-mentioned patent application is hereby incorporated by reference herein and made a part of this specification.

### BACKGROUND OF THE INVENTION

1. Field of the Invention

The invention relates to a method for adjusting moving depths of a video. Particularly, the invention relates to a method for adjusting moving depths of a video capable of avoiding or mitigating a depth inversion phenomenon.

2. Description of Related Art

With development of display technology, displays capable of providing three-dimensional (3D) images are widespread. Image information required by such 3D display includes a two-dimensional (2D) image frame and depth information thereof. According to the 2D image frame and the depth information thereof, the 3D display can reconstruct a corresponding 3D image frame.

A conventional method for estimating an image depth is to capture a depth according to a motion degree of an object, which is referred to as a “depth-from-motion (DMP)” method, by which an object with a higher motion degree is assigned with a smaller (a closer) depth, and conversely, an object with a lower motion degree is assigned with a larger (a further) depth.

Regarding a general image, the depth obtained according to the DMP method does not have a depth inversion phenomenon. However, if the image has a windowed-moving object, the depth inversion phenomenon is occurred by using the conventional DMP method. Referring to FIG. 1, FIG. 1 is a schematic diagram of an image 100 containing a windowed-moving object 120. A photographing situation of the image 100 is that a photographer himself is in a moving state, for example, the photographer sits in a moving vehicle such as an automobile or a train, and takes a picture outside the vehicle window. The windowed-moving object 120 presents a view outside the vehicle window, and a background 110 of the image 100 presents a view inside the vehicle window. In the conventional DMP method, since an object with a higher motion degree is assigned with a smaller (a closer) depth, a depth of the windowed-moving object 120 is smaller than that of the background 110, so that an observer may feel that the windowed-moving object 120 is closer than the background 110 in the image 100, which is the depth inversion phenomenon.

### SUMMARY OF THE INVENTION

A method for adjusting moving depths of a video is provided in the disclosure, which can avoid or mitigate a depth inversion phenomenon.

An embodiment of the invention provides a method for adjusting moving depths for a video, which is adapted for 2D to 3D conversion. The method includes: (i) receiving a plurality of frames at a plurality time points, and calculating relative motion characteristic data of each of the frames according to a plurality of local motion vectors and a global motion vector of each of the frames; (ii) accumulating the relative motion characteristic data of the frames to obtain first accumulated relative motion characteristic data; (iii) accumulating the relative motion characteristic data of the frames except a current frame to obtain second accumulated relative motion characteristic data; (iv) comparing the relative motion characteristic data of the current frame and the second accumulated relative motion characteristic data to obtain compared relative motion characteristic data; (v) calculating a gain value according to the first accumulated relative motion characteristic data and the compared relative motion characteristic data; and (vi) adjusting original moving depths of the current frame according to the gain value.

Another embodiment of the invention provides a method for adjusting moving depths for a video, which is adapted for 2D to 3D conversion. The method includes receiving a plurality of frames at a plurality time points and calculating a plurality of local motion vectors and a global motion vector in each of the frames. The method also includes determining a first difference degree between the local motion vectors and the global motion vector in the frames. The method further includes determining a second difference degree between a current frame and other previous frames in the frames. The method also includes calculating a gain value according to the first difference degree and the second difference degree. The method further includes adjusting original moving depths of the current frame according to the gain value.

In an embodiment of the invention, the step (i) includes: (a) calculating differences of the local motion vectors and the global motion vector of each of the frames to obtain a plurality of relative motion vectors; and (b) obtaining the relative motion characteristic data of each of the frames according to the local motion vectors and the relative motion vectors of each of the frames.

In an embodiment of the invention, the step (b) includes: (b1) determining whether an absolute value of each of the local motion vectors is greater than a first threshold; (b2) determining whether an absolute value of each of the relative motion vectors is greater than a second threshold; and (b3) obtaining the relative motion characteristic data of each of the frames according to above determination results.

In an embodiment of the invention, the step (b3) includes: calculating a plurality of comparison result values corresponding to a plurality of local units in each of the frames according to the determination results; and mapping the comparison result values along a row/column direction to generate a mapping motion vector, where the mapping motion vector represents the relative motion characteristic data.

In an embodiment of the invention, the step of generating the mapping motion vector includes: counting the comparison result values along the row/column direction to generate a plurality of counting values corresponding to different rows/columns; and respectively comparing the counting values to a third threshold, and generating a plurality of element values of the mapping motion vector according to comparison results of the counting values and the third threshold.

In an embodiment of the invention, the steps (i) to (v) are respectively implemented according to one to a plurality of directions of the frames.

In an embodiment of the invention, the relative motion characteristic data of each of the frames includes a plurality of element values corresponding to different rows/columns, and the step (ii) includes: performing an OR operation on the element values corresponding to a same row/column in the frames to obtain the first accumulated relative motion characteristic data.

In an embodiment of the invention, the step (iii) includes: performing an OR operation on the element values corresponding to a same row/column in the relative motion characteristic data of the other frames to obtain the second accumulated relative motion characteristic data.

In an embodiment of the invention, the step (iv) includes: performing an AND operation on a plurality of element values of the relative motion characteristic data and inversed element values corresponding to a same row/column in the second accumulated relative motion characteristic data, so as to obtain the compared relative motion characteristic data.

In an embodiment of the invention, the step (v) includes: obtaining a first gain value according to the first accumulated relative motion characteristic data; obtaining a second gain value according to the compared relative motion characteristic data; and calculating the gain value according to the first gain value and the second gain value.

In an embodiment of the invention, the step of obtaining the first gain value includes: obtaining the first gain value from a first gain curve according to a first summation of a plurality of element values of the first accumulated relative motion characteristic data. The step of obtaining the second gain value includes: obtaining the second gain value from a second gain curve according to a second summation of a plurality of element values of the compared relative motion characteristic data.

In an embodiment of the invention, each of the first gain value and the second gain value is calculated according to a first direction and a second direction.

In an embodiment of the invention, the step of calculating the gain value includes: obtaining a product of the first gain value and the second gain value along the first direction; obtaining a product of the first gain value and the second gain value along the second direction; and determining the gain value according to a larger one of the two products.

In an embodiment of the invention, the step of determining the first difference degree includes: calculating differences of the local motion vectors and the global motion vectors in each of the frames to obtain a plurality of relative motion vectors; obtaining the relative motion characteristic data of each of the frames according to the local motion vectors and the relative motion vectors of each of the frames; and accumulating the relative motion characteristic data of the frames to obtain first accumulated relative motion characteristic data, where the first accumulated relative motion characteristic data represents the first difference degree.

In an embodiment of the invention, the step of obtaining the relative motion characteristic data of each of the frames includes: determining whether an absolute value of each of the local motion vectors is greater than a first threshold; determining whether an absolute value of each of the relative motion vectors is greater than a second threshold; and obtaining the relative motion characteristic data of each of the frames according to above determination results.

In an embodiment of the invention, the step of determining the second difference degree includes: accumulating the relative motion characteristic data of the frames except a current frame to obtain second accumulated relative motion characteristic data; and comparing the relative motion characteristic data of the current frame and the second accumulated relative motion characteristic data to obtain compared relative motion characteristic data, where the compared relative motion characteristic data represents the second difference degree.

In an embodiment of the invention, the greater the first difference degree is, the smaller the gain value is set, and the smaller the second difference degree is, the smaller the gain value is set.

According to the above descriptions, the gain value can be obtained according to the first accumulated relative motion characteristic data and the compared relative motion characteristic data. The first accumulated relative motion characteristic data can be used to determine a difference degree of the local motion vectors and the global motion vector, and the compared relative motion characteristic data can be used to determine a difference degree of the current frame and the other previous frames. Therefore, the obtained gain value can be related to the difference degree between the local motion vectors and the global motion vector, and related to the difference degree between the current frame and the other previous frames. In this way, the moving depth of the current frame adjusted according to the gain value can more truly reflect a photographing situation, so as to avoid or mitigate the depth inversion phenomenon.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an image containing a windowed-moving object.

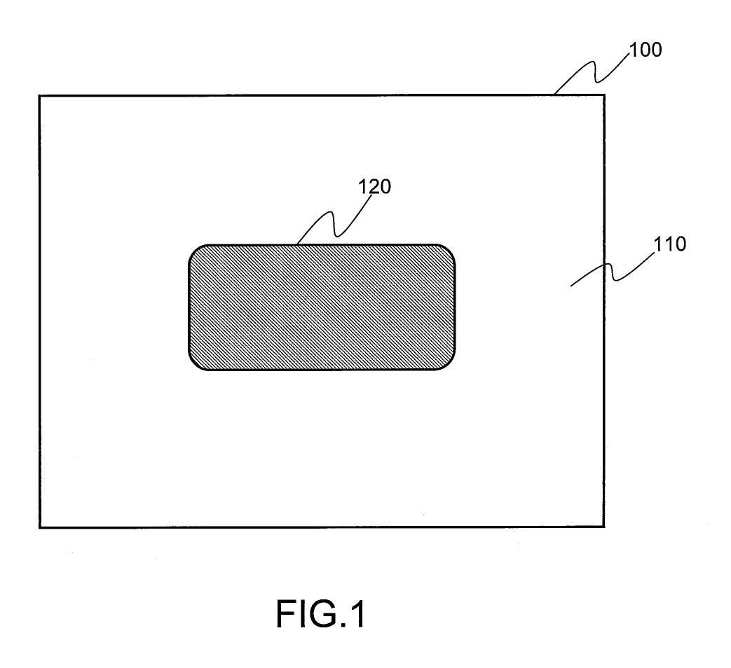

FIG. 2A is a functional block diagram of an image processing circuit according to an embodiment of the invention.

FIG. 2B is a flowchart illustrating a method for adjusting moving depths of a video according to an embodiment of the invention.

FIG. 2C is a flowchart illustrating details of a method for adjusting moving depths of a video according to an embodiment of the invention.

FIG. 3 illustrates a plurality of frames of a video of FIG. 2A in timing.

FIG. 4A illustrates local motion vectors corresponding to local units in a frame M0 according to an embodiment of the invention.

FIG. 4B illustrates relative motion vectors corresponding to local units in a frame M0 according to another embodiment of the invention.

FIG. 5A illustrates relative motion vectors corresponding to local units in a frame M0 according to an embodiment of the invention.

FIG. 5B illustrates relative motion vectors corresponding to local units in a frame M0 according to another embodiment of the invention.

FIG. 6A illustrates relative motion characteristic data, first accumulated relative motion characteristic data, second accumulated relative motion characteristic data and compared relative motion characteristic data of each of the frames according to an embodiment of the invention.

FIG. 6B illustrates relative motion characteristic data, first accumulated relative motion characteristic data, second accumulated relative motion characteristic data and compared relative motion characteristic data of each of the frames according to another embodiment of the invention.

FIG. 7A illustrates comparison result values corresponding to local units of a frame M0 according to an embodiment of the invention.

FIG. 7B illustrates comparison result values corresponding to local units of a frame M0 according to another embodiment of the invention.

FIG. 8 illustrates original moving depths corresponding to local units of a frame M0 according to an embodiment of the invention.

FIG. 9 is a schematic diagram of a first gain curve.

FIG. 10 is a schematic diagram of a second gain curve.

### DETAILED DESCRIPTION OF DISCLOSED EMBODIMENTS

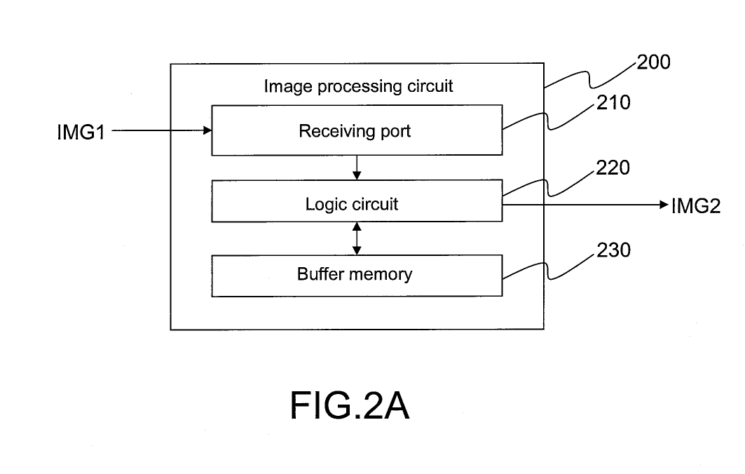

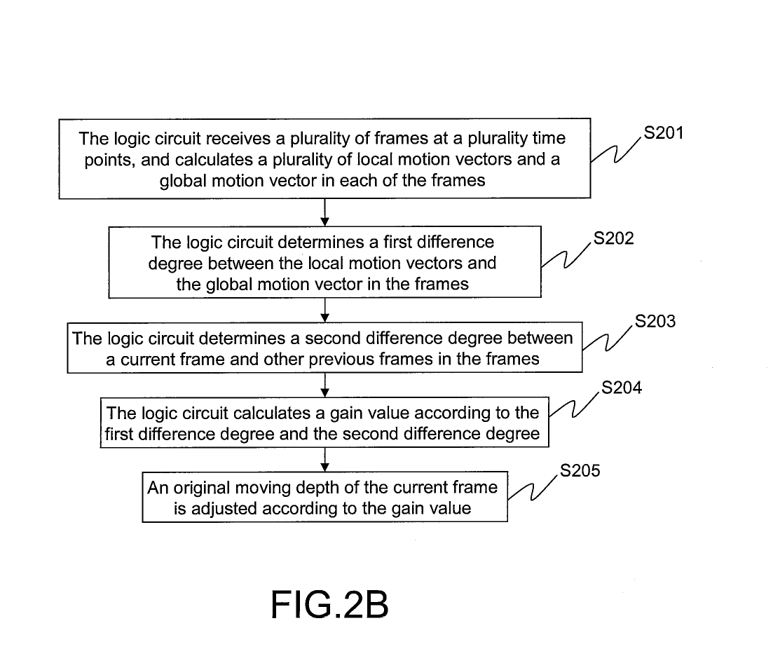

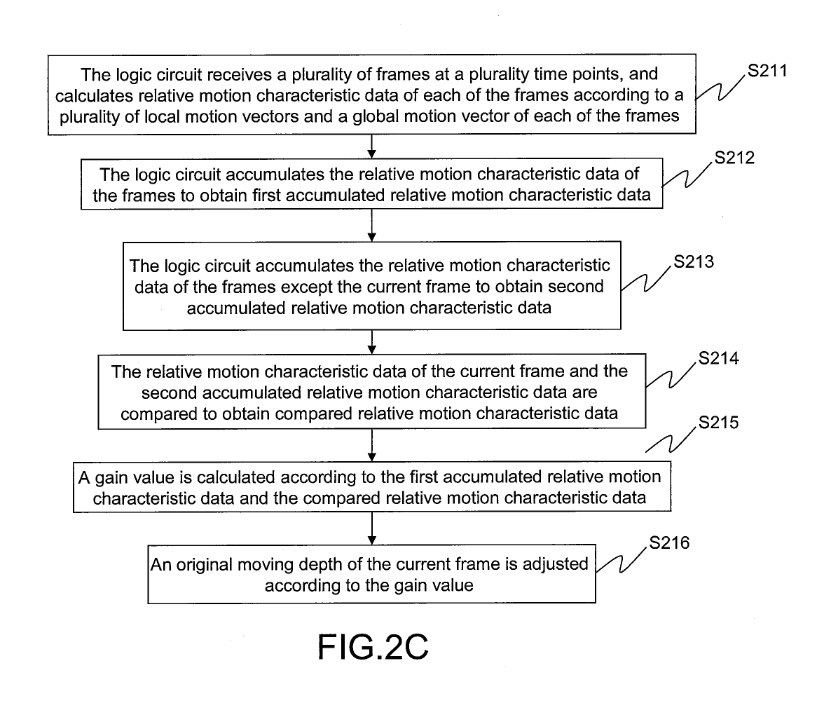

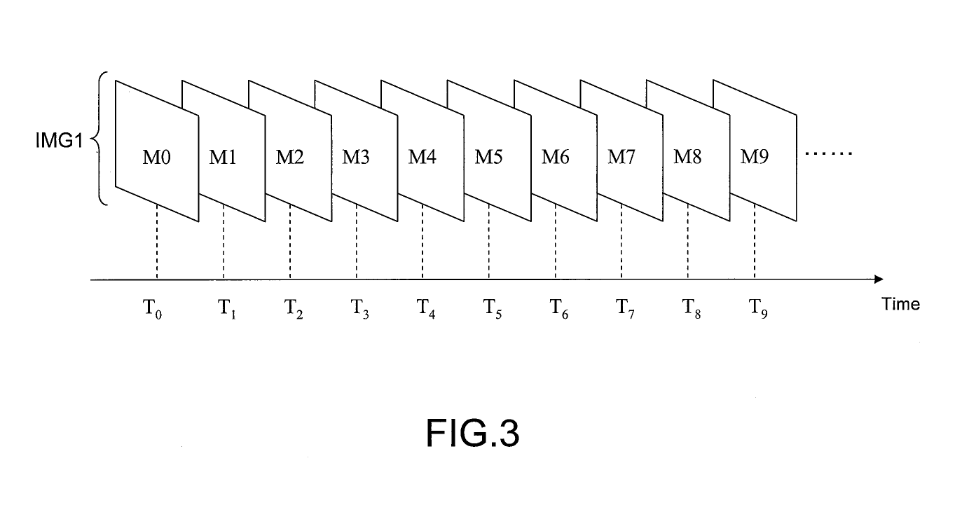

Referring to FIG. 2A, FIG. 2A is a functional block diagram of an image processing circuit 200 according to an embodiment of the invention. The image processing circuit 200 includes a receiving port 210, a logic circuit 220 and a buffer memory 230. The receiving port 210 is used for receiving a plurality of frames of a video IMG1 at a plurality time points. As shown in FIG. 3, the video IMG1 has a plurality of frames M0-M9, and the frames M0-M9 respectively corresponding to time points T₀-T₉. The frame M0 corresponds to the time point T₀, the frame M1 corresponds to the time point T₁, and deduced by analogy. Here, the frame M0 is defined as a currently processed frame, and is referred to as a “current frame”, and the other frames M1-M9 are previous frames. It should be noticed that although the video IMG1 illustrated in FIG. 3 has 10 frames, those skilled in the art should understand that the number of the frames of the video IMG1 can be other numbers.

The logic circuit 220 is coupled to the receiving port 210 for executing a method for adjusting moving depths of a video of the invention. After the logic circuit 220 adjusts the moving depth of any frame in the video IMG1, the logic circuit 220 generates and outputs a corresponding frame of another video IMG2. The moving depths of the frames of the video IMG2 are all adjusted by the logic circuit 220, and the video IMG2 can be transmitted to a display device, and then the display device displays corresponding frames according to the video IMG2.

The buffer memory 230 is coupled to the logic circuit 220 for temporarily storing data produced during the operation of the logic circuit 220. The method for adjusting moving depths of a video executed by the image processing circuit 200 is described below.

FIG. 2B is a flowchart illustrating a method for adjusting moving depths of a video according to an embodiment of the invention. The method of FIG. 2A can be executed by the image processing circuit 200. First, in step S201, the logic circuit 220 receives a plurality of frames at a plurality time points, and calculates a plurality of local motion vectors and a global motion vector in each of the frames.

Then, in step S202, the logic circuit 220 determines a first difference degree between the local motion vectors and the global motion vector in the frames. When the difference degrees between the local motion vectors and the global motion vector in several frames are relatively high, it represents that a moving object with a certain size probably exists in the frames.

Then, in step S203, the logic circuit 220 determines a second difference degree between a current frame and other previous frames in the frames. If the second difference degree is relatively great, it represents that the moving object in the frame has a certain spatial displacement within a certain time.

Then, in step S204, the logic circuit 220 calculates a gain value according to the first difference degree and the second difference degree. Preferably, the greater the first difference degree is, the smaller the gain value is set. Conversely, the smaller the second difference degree is, the smaller the gain value is set. Finally, in step S205, original moving depths of the current frame are adjusted according to the gain value.

As a result, when the above method is used, if the moving object in the frame is a windowed-moving object, the calculated first difference degree is greater, and the calculated second difference degree is smaller, so that a smaller gain value G is obtained. In this way, when the moving object in the frame is the windowed-moving object, the moving depth adjusted according to the smaller gain value G is relatively small, so that the depth inversion phenomenon is avoided or mitigated.

Comparatively, if the moving object in the frame is not a windowed-moving object, the calculated first difference degree and the second difference degree are probably greater, so that a greater gain value is generated. In this way, the adjusted moving depth is greater, and the user may view an image with a normal depth.

Referring to FIG. 2C, FIG. 2C is a flowchart illustrating details of a method for adjusting moving depths of a video according to an embodiment of the invention, which is used to describe details of the steps of FIG. 2B, and includes following steps.

First, in step S211, the logic circuit 220 receives a plurality of frames at a plurality time points, and calculates relative motion characteristic data of each of the frames according to a plurality of local motion vectors and a global motion vector of each of the frames. The relative motion characteristic data represents a difference degree of the local motion vectors and the global motion vector in each of the frames.

Then, in step S212, the logic circuit 220 accumulates the relative motion characteristic data of the frames to obtain first accumulated relative motion characteristic data. The first accumulated relative motion characteristic data represents the first difference degree of FIG. 2B.

Then, in step S213, the logic circuit 220 accumulates the relative motion characteristic data of the frames except the current frame to obtain second accumulated relative motion characteristic data. Then, in step S214, the relative motion characteristic data of the current frame and the second accumulated relative motion characteristic data are compared to obtain compared relative motion characteristic data. The compared relative motion characteristic data represents the second difference degree of FIG. 2B.

Then, in step S215, a gain value is calculated according to the first accumulated relative motion characteristic data and the compared relative motion characteristic data. Finally, in step S216, the original moving depths of the current frame are adjusted according to the gain value.

It should be noticed that the steps S211-S215 can be respectively executed according to one to a plurality of directions of the frames, for example, a horizontal direction X or/and a vertical direction Y. When the steps S211-S215 are executed according to multiple directions of the frames, the multiple directions can be the horizontal direction X and the vertical direction Y. Embodiments are provided below to describe the steps of the method for adjusting moving depths of a video of FIG. 2C in detail.

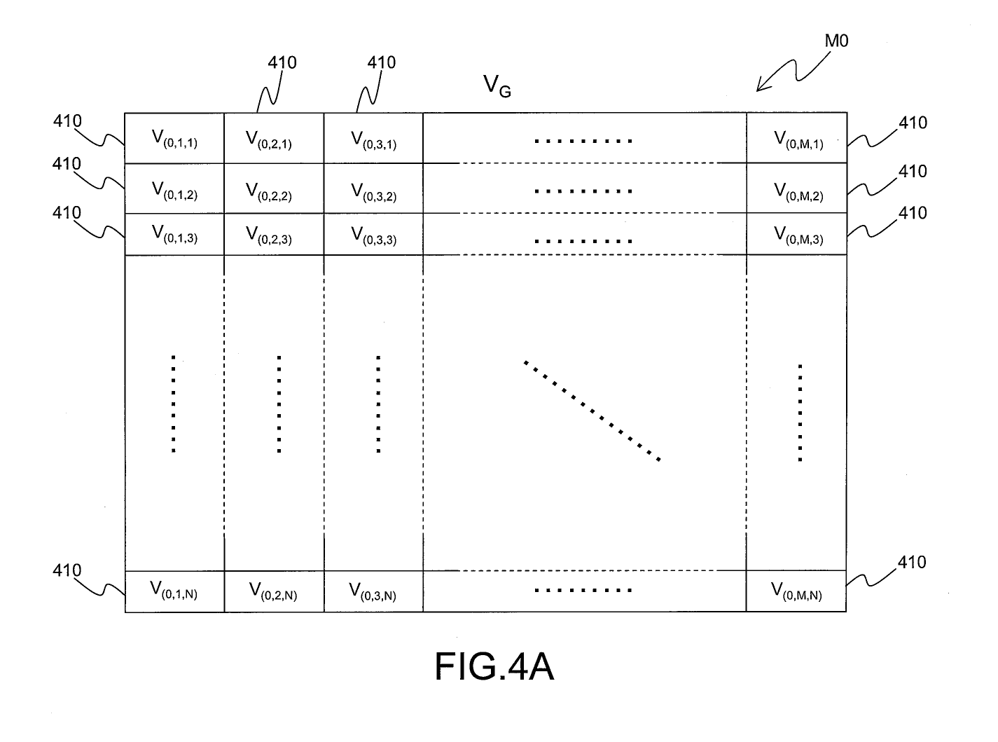

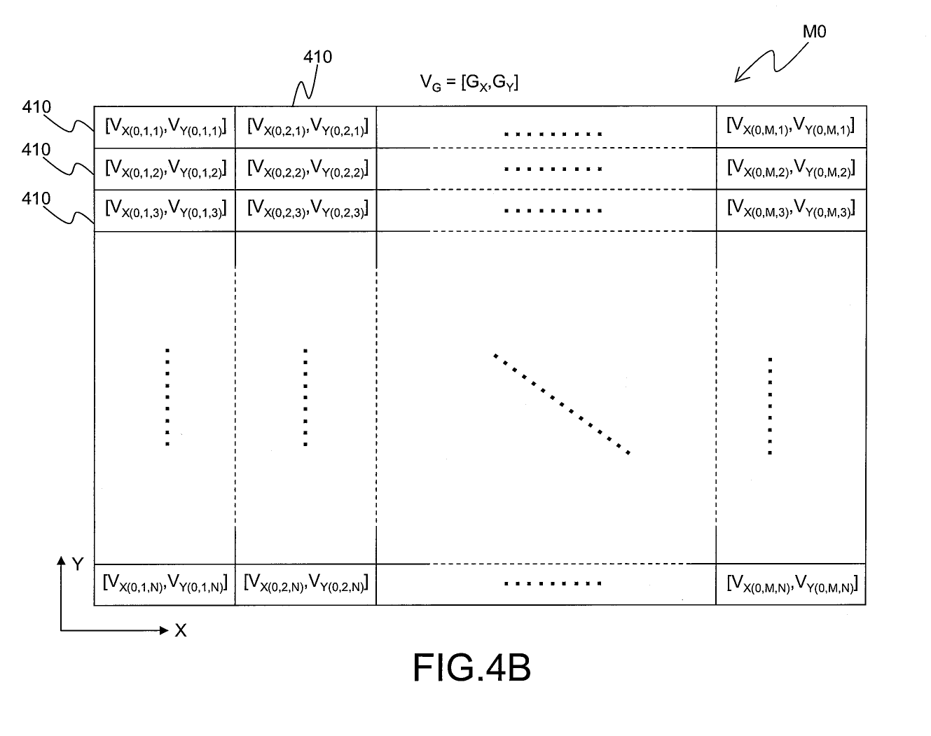

First, in step S211, the logic circuit 220 calculates a plurality of local motion vectors corresponding to a plurality of local units 410 and a global motion vector V_{G} in each of the frames M0-M9. Referring to FIG. 4A, FIG. 4A illustrates local motion vectors corresponding to local units in the frame M0 according to an embodiment of the invention. The frame M0 is divided into a plurality of the local units 410, and each of the local units 410 has one or a plurality of pixels of the frame M0, and the local units 410 are arranged as an array of M columns and N rows, where M and N are positive integers. Similar to the frame M0, each of the other frames (for example, the frames M1-M9) of the video IMG1 has the local units 410 arranged in the array of M columns and N rows.

For simplicity's sake, as shown in FIG. 4A, the local motion vectors corresponding to the local units 410 in the frame M0 that are calculated by the logic circuit 220 are respectively represented by V_{(0,1,1)} to V_{(0,M,N)}. Similarly, a local motion vector corresponding to the local unit 410 of a j^{th} column and a k^{th} row in a frame Mi at a time point Ti is represented by V_{(i,j,k)}, where 0≦i, 1≦j≦M, 1≦k≦N. A method of calculating the local motion vectors and the global motion vector V_{G} can be a method of calculating local motion vectors and a global motion vector used in a depth-from-motion (DMP) method, and the DMP method is known by those skilled in the art, which is not repeated herein.

It should be noticed that in calculation, each of the local motion vectors is preferably includes components of two directions, for example, a horizontal motion vector and a vertical motion vector, where the horizontal motion vector and the vertical motion vector are perpendicular to each other. Referring to FIG. 4B, FIG. 4B illustrates relative motion vectors corresponding to the local units 410 in the frame M0 according to another embodiment of the invention. For simplicity's sake, the local motion vector corresponding to the local unit 410 of the j^{th} column and the k^{th} row in the frame Mi at the time point Ti is represented by [V_{X(i,j,k)}, V_{Y(i,j,k)}], where 0≦i, 1≦j≦M, 1≦k≦N. V_{X(i,j,k)} represents a horizontal component of the local motion vector along the horizontal direction X, and V_{Y(i,j,k)} represents a vertical component of the local motion vector along the vertical direction Y. Taking FIG. 4B as an example, the local motion vectors corresponding to the local units 410 in the frame M0 that are calculated by the logic circuit 220 are respectively represented by [V_{X(0,1,1)}, V_{Y(0,1,1)}] to [V_{X(0,M,N)}, V_{Y(0,M,N)}]. Moreover, the global motion vector V_{G} calculated by the logic circuit 220 is represented by [G_{X}, G_{Y}], where G_{X} is a component of the global motion vector V_{G} along the horizontal direction X, and G_{Y} is a component of the global motion vector V_{G} along the vertical direction Y.

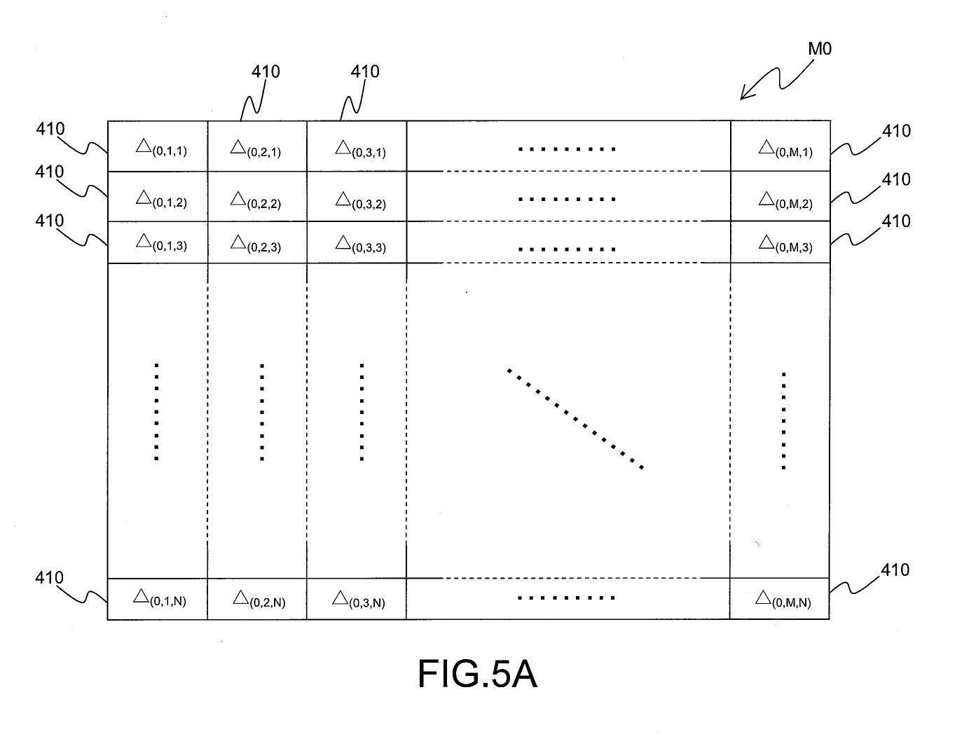

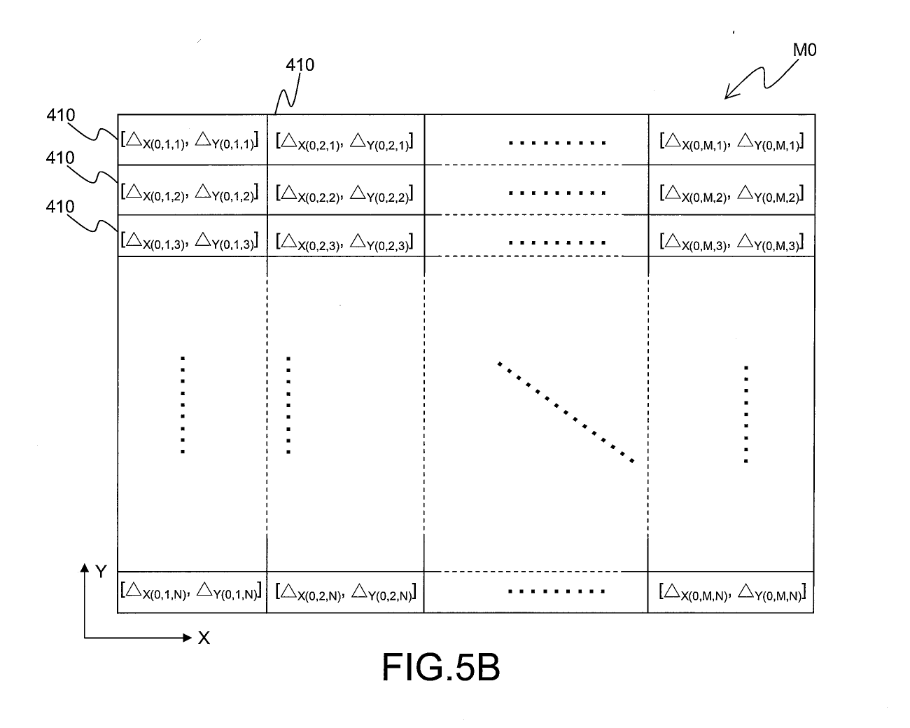

Then, the logic circuit 220 compares the local motion vectors and the global motion vector V_{G} of each of the frames to obtain a plurality of relative motion vectors. For simplicity's sake, the relative motion vector corresponding to the local unit 410 of the j^{th} column and the k^{th} row in the frame Mi at the time point Ti is represented by Δ_{(i,j,k)}, where 0≦i, 1≦j≦M, 1≦K≦N. Referring to FIG. 5A, FIG. 5A illustrates relative motion vectors corresponding to the local units 410 in the frame M0 according to an embodiment of the invention. In FIG. 5A, the relative motion vectors corresponding to the local units 410 in the frame M0 that are calculated by the logic circuit 220 are respectively represented by Δ_{(0,1,1)} to Δ_{(0,M,N)}.

In an embodiment of the invention, the logic circuit 220 calculates differences of the local motion vectors and the global motion vector V_{G} of each of the frames to obtain the relative motion vectors. In other words, the relative motion vector is obtained according to a following equation (1):

Δ_{(i,j,k)}=V_{(i,j,k)}−V_{G} (1)

It should be noticed that when the relative motion vector Δ_{(i,j,k)} is calculated, the components of two directions are preferably calculated. Referring to FIG. 5B, FIG. 5B illustrates relative motion vectors corresponding to the local units 410 in the frame M0 according to another embodiment of the invention. For simplicity's sake, the relative motion vector corresponding to the local unit 410 of the j^{th} column and the k^{th} row in the frame Mi at the time point Ti is represented by [Δ_{X(i,j,k)}, Δ_{Y(i,j,k)}], where 0≦i, 1≦j≦M, 1≦k≦N. Δ_{X(i,j,k)} represents a component of the relative motion vector along the horizontal direction X, and Δ_{Y(i,j,k)} represents a component of the relative motion vector along the vertical direction Y. Taking FIG. 5B as an example, the relative motion vectors corresponding to the local units 410 in the frame M0 that are calculated by the logic circuit 220 are respectively represented by [Δ_{X(i,1,1)}, Δ_{Y(i,1,1)}] to [Δ_{X(i,M,N)}, Δ_{Y(i,M,N)}]. In an embodiment of the invention, the components of each of the relative motion vectors along the horizontal direction X and the vertical direction Y are obtained according to following equations (1-1) and (1-2):

Δ_{X(i,j,k)}=V_{X(i,j,k)}−G_{X} (1-1)

Δ_{Y(i,j,k)}=V_{(i,j,k)}−G_{Y} (1-2)

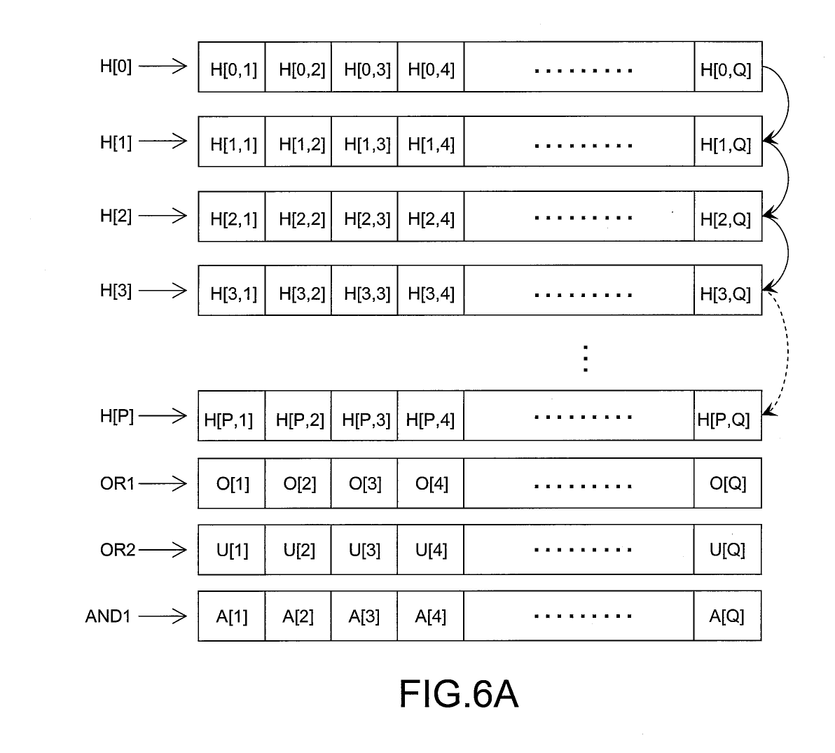

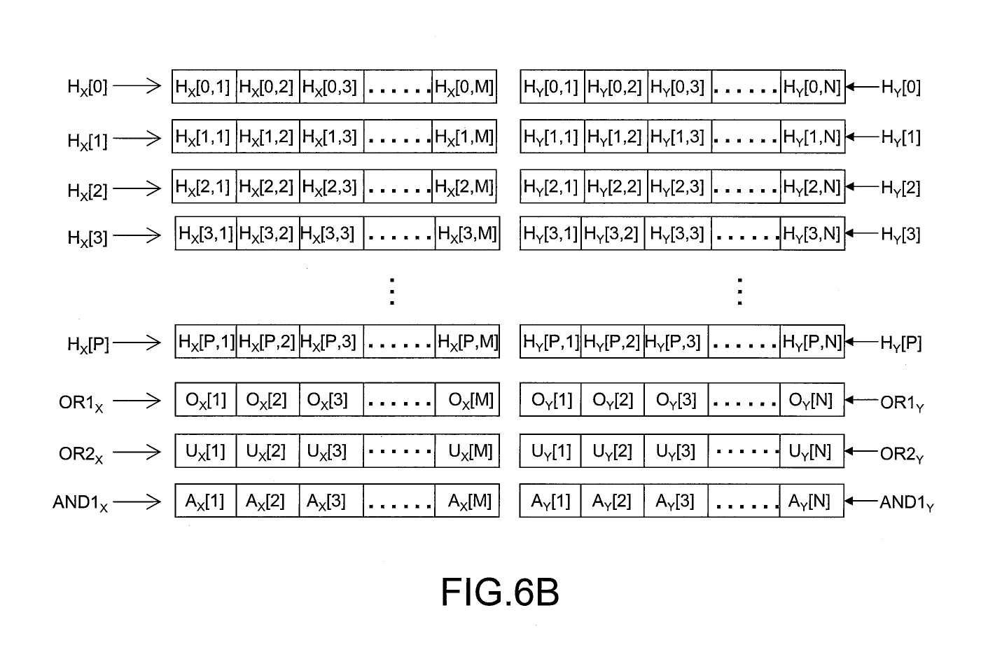

Then, the logic circuit 220 obtains relative motion characteristic data of each of the frames according to the local motion vectors and the relative motion vectors of each of the frames. Referring to FIG. 6A, FIG. 6A illustrates relative motion characteristic data of each of the frames. H[0] represents relative motion characteristic data of the frame M0, H[1] represents relative motion characteristic data of the frame M1, H[2] represents relative motion characteristic data of the frame M2, and deduced by analogy.

In an embodiment of the invention, the relative motion characteristic data H[0] to H[P] are respectively represented by a one-dimensional matrix or a vector. As shown in FIG. 6A, each of the relative motion characteristic data H[0] to H[P] includes a plurality of element values corresponding to different rows/columns. Taking the relative motion characteristic data H[1] as an example, the relative motion characteristic data H[1] includes a plurality of element values H[1,1] to H[1,Q] respectively corresponding to a first to an M^{th} columns of the frame M1, or corresponding to a first to an N^{th} rows of the frame M1. Taking the relative motion characteristic data H[P] as an example, the relative motion characteristic data H[P] includes a plurality of element values H[P,1] to H[P,Q] respectively corresponding to a first to an M^{th} columns of the frame MP, or corresponding to a first to an N^{th} rows of the frame MP, where an element value H[s,t] represents a t^{th} element value of the relative motion characteristic data H[s] corresponding to a frame at a time point T.

Moreover, it should be noticed that as shown in FIG. 6B, when the relative motion characteristic data H[0] to H[P] of the frames are calculated, a horizontal component and a vertical component are preferably calculated, respectively. For example, the relative motion characteristic data (H_{X}[0], H_{Y}[0]) of the frame M0 includes a horizontal component H_{X}[0] and a vertical component H_{Y}[0], the relative motion characteristic data (H_{X}[1], H_{Y}[1]) of the frame M1 includes a horizontal component H_{X}[1] and a vertical component H_{Y}[1], the relative motion characteristic data (H_{X}[2], H_{Y}[2]) of the frame M2 includes a horizontal component H_{X}[2] and a vertical component H_{Y}[2], and deduced by analogy.

In detail, a j^{th} element value of the horizontal component H_{X}[i] of the relative motion characteristic data (H_{X}[i], H_{Y}[i]) corresponding to the frame at the time point Tₛ can be represented by H_{X}[i,j], and a k^{ill} element value of the vertical component H_{Y}[i] of the relative motion characteristic data (H_{X}[i], H_{Y}[i]) corresponding to the frame at the time point Tₛ can be represented by H_{Y}[i,k], where, 1≦j≦M, 1≦k≦N. Taking the relative motion characteristic data (H_{X}[1], H_{Y}[1]) as an example, the horizontal component H_{X}[1] thereof includes a plurality of element values H_{X}[1,1] to H_{X}[1,M], and the vertical component H_{Y}[1] thereof includes a plurality of element values H_{Y}[1,1] to H_{Y}[1,N]. Taking the relative motion characteristic data (H_{X}[P], H_{Y}[P]) as an example, the horizontal component H_{X}[P] thereof includes a plurality of element values H_{X}[P,1] to H_{X}[P,M], and the vertical component H_{Y}[P] thereof includes a plurality of element values H_{Y}[P,1] to H_{Y}[P,N].

In the aforementioned embodiment, each of the element values of the relative motion characteristic data H[1] to H[P] shown in FIG. 6A serves as a symbol representing whether an absolute value of each of the local motion vectors V_{(i,j,k)} and an absolute value of each of the relative motion vectors Δ_{(i,j,k)} on a corresponding row/column are great enough. A detailed calculation method for obtaining the relative motion characteristic data H[0] to H[P] is described below.

Regarding a process of obtaining the relative motion characteristic data H[0] to H[P], in an embodiment, during a process that the logic circuit 220 obtains the relative motion characteristic data H[0] to H[P] of the frames, the logic circuit 220 first determines whether an absolute value of each of the local motion vectors V_{(i,j,k)} is greater than a first threshold, and determines whether an absolute value of each of the relative motion vectors Δ_{(i,j,k)} is greater than a second threshold, and obtains the relative motion characteristic data H[0] to H[P] of each of the frames according to aforementioned two determination results.

Regarding a process of obtaining the relative motion characteristic data H[0] to H[P] of each of the frames according to the aforementioned two determination results, in an embodiment, the logic circuit 220 first calculates a plurality of comparison result values A_{(i,j,k)} corresponding to the local units 410 in each of the frames, where the comparison result value represents the aforementioned two determination results, and the logic circuit 220 maps the comparison result values A_{(i,j,k)} along a row/column direction to generate a mapping motion vector C_{X}[0] or C_{Y}[0], where the mapping motion vector C_{X}[0] or C_{Y}[0] is used to represent the relative motion characteristic data H[0] to H[P].

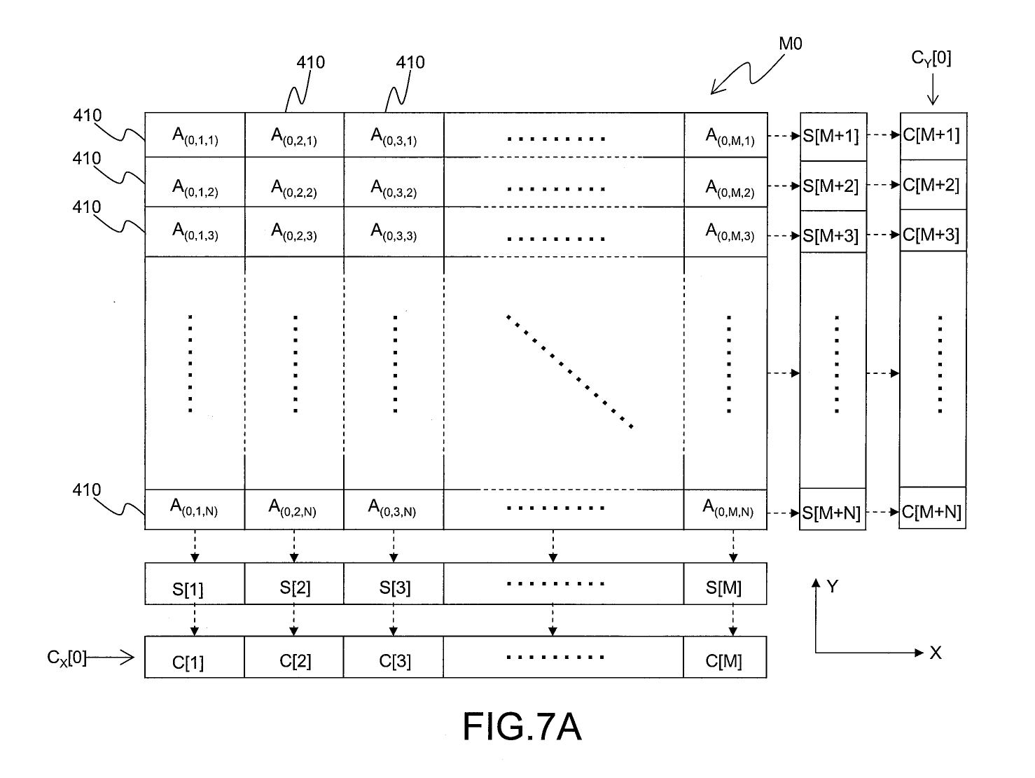

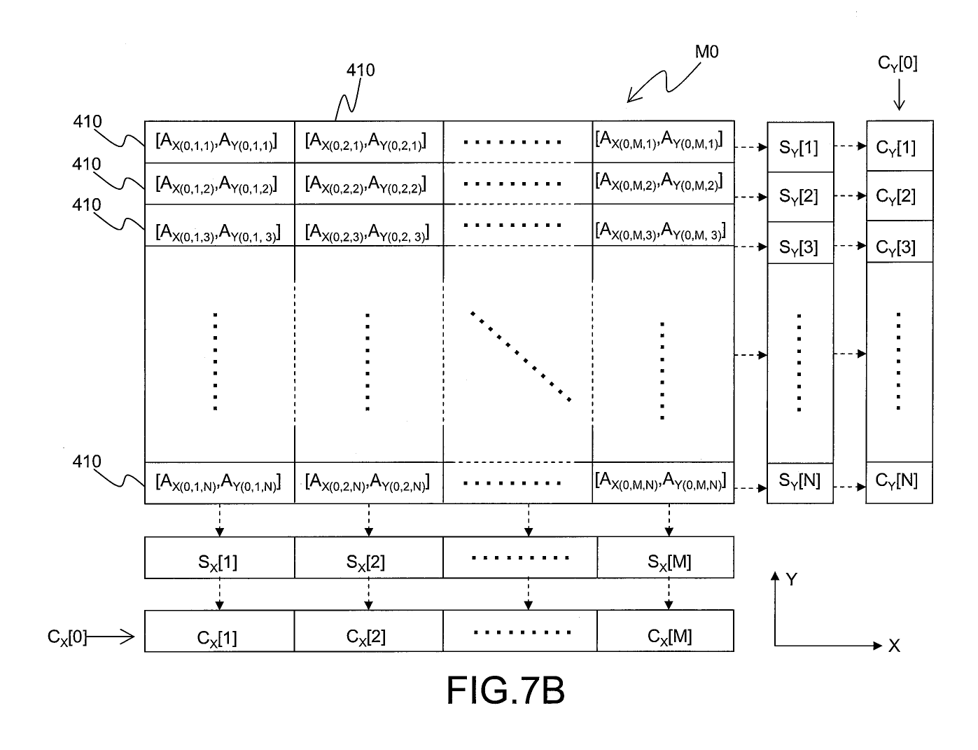

Referring to FIG. 7A, FIG. 7A illustrates the comparison result values A_{(i,j,k)} corresponding to the local units 410 of the frame M0, which is used to describe a process of generating the comparison result values A_{(i,j,k)} and the mapping motion vector C_{X}[0] or C_{Y}[0]. For simplicity's sake, the comparison result value corresponding to the local unit 410 of the j^{th} column and the k^{th} row in the frame Mi at the time point Ti is represented by A_{(i,j,k)}, where 0≦i, 1≦j≦M, 1≦k≦N. In FIG. 7A, the comparison result values corresponding to the local units 410 in the frame M0 that are calculated by the logic circuit 220 are respectively represented by A_{(0,1,1)} to A_{(0,m,n)}.

In an embodiment of the invention, the comparison result values are obtained according to a following equation (2):

$${A}_{( i , j , k )} = \{ \begin{matrix}1 , if \vert {V}_{( i , j , k )} \vert > Th 1 and \vert {Δ}_{( i , j , k )} \vert > Th 2 \\ 0 , if \vert {V}_{( i , j , k )} \vert ≦ Th 1 or \vert {Δ}_{( i , j , k )} \vert ≦ Th 2\end{matrix} \qquad ( 2 )$$

Where, Th1 is the first threshold, and Th2 is the second threshold. In other words, if |V_{(i,j,k)}| is greater than the first threshold Th1 and |Δ_{(i,j,k)}| is greater than the second threshold Th2, the comparison result value A_{(i,j,k)} is set to 1. Comparatively, if |V_{(i,j,k)}| is not greater than the first threshold Th1 or |Δ_{(i,j,k)}| is not greater than the second threshold Th2, the comparison result value A_{(i,j,k)} is set to 0. Therefore, the comparison result value A_{(i,j,k)} is set to 1 only when |V_{(i,j,k)}| and |Δ_{(i,j,k)}| are great enough, otherwise, the comparison result values A_{(i,j,k)} are all set to 0.

After the comparison result values A_{(i,j,k)} are obtained, the logic circuit 220 maps the comparison result values A_{(i,j,k)} along the row/column direction to generate a mapping motion vector C_{X}[0] or C_{Y}[0], where the mapping motion vector C_{X}[0] or C_{Y}[0] represents the relative motion characteristic data. The so-called row/column direction is, for example, the horizontal direction X or the vertical direction Y, where the horizontal direction X and the vertical direction Y are perpendicular to each other. Taking FIG. 7A as an example, the logic circuit 220 can map the comparison result values A_{(0,1,1)} to A_{(0,m,n)} in the frame M0 along the horizontal direction X to generate the mapping motion vector C_{X}[0]. Alternatively, the logic circuit 220 can map the comparison result values A_{(0,1,1)} to A_{(0,m,n)} in the frame M0 along the vertical direction Y to generate the mapping motion vector C_{Y}[0]. As shown in FIG. 7A, the mapping motion vector C_{X}[0] has a plurality of element values C[1] to C[M], and the mapping motion vector C_{Y}[0] has a plurality of element values C[M+1] to C[M+N]. Each of the element values C[1] to C[M+N] corresponds to local units 410 or a column or a row.

In an embodiment, during the process that the logic circuit 220 maps the comparison result values along the row/column direction to generate the mapping motion vector, the logic circuit 220 counts the comparison result values along the row/column direction to generate a plurality of counting values corresponding to different rows/columns, and respectively compares the counting values to a third threshold Th3, so as to generate the element values of the mapping motion vector according to comparison results of the counting values and the third threshold.

Taking the frame M0 of FIG. 7A as an example, if the row/column mapping direction is the vertical direction Y, i.e. Q is equal to M, the logic circuit 220 counts the comparison result values A_{(0,1,1)} to A_{(0,m,n)} along the vertical direction Y to generate a plurality of counting values S[1] to S [M] corresponding to different columns, and respectively compares the counting values S[1] to S[M] to the third threshold Th3, so as to generate the element values C[1] to C[M] of the mapping motion vector C_{X}[0] according to comparison results of the counting values S[1] to S[M] and the third threshold Th3. The counting values S[1] to S[M] are obtained according to a following equation (3), and the element values C[1] to C[M] are obtained according to a following equation (4):

$$\begin{matrix}S [ j ] = {\sum }_{k = 1}^{N} {A}_{( 0 , j , k )} & ( 3 ) \\ C [ j ] = \{ \begin{matrix}1 , if S [ j ] > Th 3 \\ 0 , if S [ j ] ≦ Th 3\end{matrix} & ( 4 )\end{matrix}$$

Where, the mapping motion vector C_{X}[0] of FIG. 7A is the relative motion characteristic data H[0] of FIG. 6A, and the element values C[1] to C[M] are the element values H[0,1] to H[0,Q] of the relative motion characteristic data H[0].

Similarly, if the row/column mapping direction is the horizontal direction X, i.e. Q is equal to N, the logic circuit 220 counts the comparison result values A_{(0,1,1)} to A_{(0,m,n)} along the horizontal direction X to generate a plurality of counting values S[M+1] to S[M+N] corresponding to different rows, and respectively compares the counting values S[M+1] to S[M+N] to the third threshold Th3, so as to generate the element values C[M+1] to C[M+N] of the mapping motion vector C_{Y}[0] according to comparison results of the counting values S[M+1] to S[M+N] and the third threshold Th3. The counting values S[M+1] to S[M+N] are obtained according to a following equation (5), and the element values C[M+1] to C[M+N] are obtained according to a following equation (6):

$$\begin{matrix}S [ M + k ] = {\sum }_{j = 1}^{M} {A}_{( 0 , j , k )} & ( 5 ) \\ C [ M + k ] = \{ \begin{matrix}1 , if S [ M + k ] > Th 3 \\ 0 , if S [ M + k ] ≦ Th 3\end{matrix} & ( 6 )\end{matrix}$$

Where, the mapping motion vector C_{Y}[0] of FIG. 7A is the relative motion characteristic data H[0] of FIG. 6A, and the element values C[M+1] to C[M+N] are the element values H[0,1] to H[0,Q] of the relative motion characteristic data H[0].

It should be noticed that as described above, during the process of calculating the relative motion characteristic data, a horizontal component and a vertical component thereof are preferably calculated. Therefore, in an embodiment of the invention, the logic circuit 220 can respectively compare an absolute value of a horizontal component V_{X(i,j,k)} and an absolute value of a vertical component V_{Y(i,j,k)} of each of the local motion vectors [V_{X(i,j,k)}, V_{Y(i,j,k)}] with the first threshold Th1, and compare an absolute value of a horizontal component Δ_{X(i,j,k)} and an absolute value of a vertical component Δ_{Y(i,j,k)} of each of the relative motion vectors [Δ_{X(i,j,k)}, Δ_{Y(i,j,k)}] with the second threshold Th2. Then, the logic circuit 220 obtains the relative motion characteristic data of each of the frames according to the above comparison results.

Moreover, the logic circuit 220 can also map a plurality of comparison result values representing the above comparison results along the horizontal direction X and the vertical direction Y to generate horizontal mapping motion vectors and vertical mapping motion vectors, which respectively represent the horizontal components and the vertical components of the relative motion characteristic data. Referring to FIG. 7B, FIG. 7B illustrates comparison result values corresponding to the local units 410 of the frame M0 of FIG. 6B. The comparison result value corresponding to the local unit 410 of the j^{th} column and the k^{th} row in the frame Mi at the time point Ti is represented by [A_{X(i,j,k)}, A_{Y(i,j,k)}] where 0≦i, 1≦j≦M, 1≦k≦N, and each of the comparison result values [A_{X(i,j,k)}, A_{Y(i,j,k)}] includes a horizontal comparison result value A_{X(i,j,k)} and a vertical comparison result value A_{Y(i,j,k)}.

Similar to the equation (5), in an embodiment of the invention, the horizontal comparison result value A_{X(i,j,k)} and the vertical comparison result value A_{Y(i,j,k)} are obtained according to following equations (2-1) and (2-2):

$$\begin{matrix}{{A}_{X}}_{( i , j , k )} = \{ \begin{matrix}1 , if \vert {V}_{X ( i , j , k )} \vert > Th 1 and \vert {Δ}_{X ( i , j , k )} \vert > Th 2 \\ 0 , if \vert {V}_{X ( i , j , k )} \vert ≦ Th 1 or \vert {Δ}_{X ( i , j , k )} \vert ≦ Th 2\end{matrix} & ( 2 - 1 ) \\ {{A}_{Y}}_{( i , j , k )} = \{ \begin{matrix}1 , if \vert {V}_{Y ( i , j , k )} \vert > Th 1 and \vert {Δ}_{Y ( i , j , k )} \vert > Th 2 \\ 0 , if \vert {V}_{Y ( i , j , k )} \vert ≦ Th 1 or \vert {Δ}_{Y ( i , j , k )} \vert ≦ Th 2\end{matrix} & ( 2 - 2 )\end{matrix}$$

Then, according to a similar method, the logic circuit 220 maps the horizontal comparison result values A_{X(0,1,1)} to A_{X(0,M,N)} in the frame M0 along the vertical direction Y to generate the horizontal mapping motion vector C_{X}[0], and the logic circuit 220 maps the vertical comparison result values A_{Y(0,1,1)} to A_{Y(0,M,N)} in the frame M0 along the horizontal direction X to generate the vertical mapping motion vector C_{Y}[0].

During the process of generating the horizontal mapping motion vector C_{X}[0] and the vertical mapping motion vector C_{Y}[0], the logic circuit 220 also counts the horizontal comparison result values A_{X(0,1,1)} to A_{X(0,M,N)} along the vertical direction Y to generate a plurality of counting values S_{X}[1] to S_{X}[M] corresponding to different columns, and counts the vertical comparison result values A_{Y(0,1,1)} to A_{Y(0,M,N)} along the horizontal direction X to generate a plurality of counting values S_{Y}[1] to S_{Y}[N] corresponding to different rows. Then, the logic circuit 220 can generate a plurality of element values C_{X}[1] to C_{X}[M] of the horizontal mapping motion vector C_{X}[0] and a plurality of element values C_{Y}[1] to C_{Y}[N] of the vertical mapping motion vector C_{Y}[0] according to following equations, where the counting values S_{X}[1] to S_{X}[M] and counting values S_{Y}[1] to S_{Y}[N] are obtained according to following equations (3-1) and (5-1), and the element values C_{X}[1] to C_{X}[M] and C_{Y}[1] to C_{Y}[N] are obtained according to following equations (4-1) and (6-1):

$$\begin{matrix}{S}_{X} [ j ] = {\sum }_{k = 1}^{N} {A}_{X ( 0 , j , k )} & ( 3 - 1 ) \\ {C}_{X} [ j ] = \{ \begin{matrix}1 , if {S}_{X} [ j ] > Th 3 \\ 0 , if {S}_{X} [ j ] ≦ Th 3\end{matrix} & ( 4 - 1 ) \\ {S}_{Y} [ k ] = {\sum }_{j = 1}^{M} {A}_{Y ( 0 , j , k )} & ( 5 - 1 ) \\ {C}_{Y} [ k ] = \{ \begin{matrix}1 , if {S}_{Y} [ k ] > Th 3 \\ 0 , if {S}_{Y} [ k ] ≦ Th 3\end{matrix} & ( 6 - 1 )\end{matrix}$$

Moreover, it should be noticed that each of the element values of the relative motion characteristic data H[0] to H[Q] (regardless of Hx[0] to H[M] or Hx[0] to H[N]) serves as a symbol representing whether an absolute value of each of the local motion vectors V_{(i,j,k)} and an absolute value of each of the relative motion vectors Δ_{(i,j,k)} on a corresponding row/column are great enough. Therefore, in other embodiments, the relative motion characteristic data H[0] to H[P] can be calculated according to different methods, which are not limited to the method introduced in the aforementioned embodiment.

Referring to FIG. 2C and FIG. 6A, after the logic circuit 220 obtains the relative motion characteristic data H[0] to H[P] of each of the frames, the logic circuit 220 executes the step S212 to accumulate the relative motion characteristic data H[0] to H[P] of (P+1) frames to obtain first accumulated relative motion characteristic data OR1.

In an embodiment, the logic circuit 220 performs an OR operation on the element values corresponding to a same row/column in the (P+1) frames to obtain the first accumulated relative motion characteristic data OR1. Mathematically, the first accumulated relative motion characteristic data OR1 has a plurality of element values O(1) to O(Q), and each of the element values O(1) to O(Q) is obtained by performing the OR operation on the element values corresponding to the same row/column in the relative motion characteristic data H[0] to H[P]. In detail, the element values O(1) to O(Q) are obtained according to a following equation (7):

O[q]=H[0,q] [symbol] H[1,q] [symbol] H[2,q] [symbol] . . . H[P,q] (7)

Where, 1≦q≦Q.

Referring to FIG. 6B, after the logic circuit 220 obtains the horizontal components H_{X}[0] to H_{X}[P] and the vertical components H_{Y}[0] to H_{Y}[P] of the relative motion characteristic data of the frames, the logic circuit 220 accumulates the relative motion characteristic data of each of the frames to obtain the first accumulated relative motion characteristic data (OR1_{X}, OR1_{Y}), where OR_{X} represents a horizontal component of the first accumulated relative motion characteristic data, and OR1_{Y} represents a vertical component of the first accumulated relative motion characteristic data. In other words, the logic circuit 220 accumulates the horizontal components H_{X}[0] to H_{X}[P] and the vertical components H_{Y}[0] to H_{Y}[P] of the relative motion characteristic data of the (P+1) frames to obtain the first accumulated relative motion characteristic data (OR1_{X}, OR1_{Y}).

It should be noticed that as shown in FIG. 6B, the first accumulated relative motion characteristic data can also be respectively calculated along the vertical direction and the horizontal direction. Further, the first accumulated relative motion characteristic data (OR1_{X}, OR1_{Y}) has a plurality of element values O_{X}[1] to O_{X}[M] and O_{Y}[1] to O_{Y}[N], which are, for example, obtained according to following equations (7-1) and (7-2):

O_{X}[j]=H_{X}[0,j] [symbol] H_{X}[1,j] [symbol] H_{X}[2,j] [symbol] . . . H_{X}[P,j] (7-1)

O_{Y}[k]=H_{Y}[0,k] [symbol] H_{Y}[1,k] [symbol] H_{Y}[2,k] [symbol] . . . H_{Y}[P,k] (7-2)

Where, 1≦j≦M, 1≦k≦N

Moreover, it should be noticed that the first accumulated relative motion characteristic data OR1 or (OR1_{X}, OR1_{Y}) is used to determine an overall difference degree between the local motion vectors and the global motion vector of a plurality of continuous frames. When the difference degrees between the local motion vectors and the global motion vector in the several frames are relatively high, it represents that a moving object with a certain size probably exists in the frames. Therefore, in the other embodiments, other methods can be used to calculate the first accumulated relative motion characteristic data OR1 to represent the difference, which are not limited to the method introduced in the aforementioned embodiment.

Then, the step S213 of FIG. 2C is described. Besides obtaining the first accumulated relative motion characteristic data OR1, the logic circuit 220 accumulates the relative motion characteristic data H[1] to H[P] of the other frames except the current frame M0 to obtain second accumulated relative motion characteristic data OR2, as that shown in FIG. 6A. In an embodiment of the invention, the second accumulated relative motion characteristic data OR2 includes a plurality of element values U[1] to U[Q] corresponding to different rows/columns. Similar to the first accumulated relative motion characteristic data OR1, each of the element values U[1] to U[Q] is obtained by performing the OR operation on the element values corresponding to the same row/column in the relative motion characteristic data H[1] to H[P] of the other frames by the logic circuit 220. In detail, the element values U(1) to U(Q) are obtained according to a following equation (8):

U[q]=H[1,q] [symbol] H[2,q] [symbol] H[3,q] [symbol] . . . H[P,q] (8)

Where, 1≦q≦Q.

It should be noticed that as shown in FIG. 6B, the logic circuit 220 can also calculate the second accumulated relative motion characteristic data (OR2_{X}, OR2_{Y}) along two directions, where OR2_{X} represents a horizontal component of the second accumulated relative motion characteristic data, and OR2_{Y} represents a vertical component of the second accumulated relative motion characteristic data. In an embodiment of the invention, the second accumulated relative motion characteristic data (OR2_{X}, OR2_{Y}) includes a plurality of element values U_{X}[1] to U_{X}[M] and U_{Y}[1] to U_{Y}[N] corresponding to different rows/columns, which are, for example, obtained according to following equations (8-1) and (8-2):

U_{X}[j]=H_{X}[1,j] [symbol] H_{X}[2,j] [symbol] H_{X}[3,j] [symbol] . . . H_{X}[P,j] (8-1)

U_{Y}[k]=H_{Y}[1,k] [symbol] H_{Y}[2,k] [symbol] H_{Y}[3,k] [symbol] . . . H_{Y}[P,k] (8-2)

Where, 1≦j≦M, 1≦k≦N.

Then, the step S14 of FIG. 2C is described. The logic circuit 220 compares the relative motion characteristic data H[0] of the current frame M0 and the second accumulated relative motion characteristic data OR2 to obtain compared relative motion characteristic data AND1 (shown in FIG. 6A). During the comparison process, for example, an AND operation can be performed on the relative motion characteristic data H[0] of the current frame M0 and inversed data (with an element value 1 changed to 0, and 0 changed to 1) of the second accumulated relative motion characteristic data OR2, so as to obtain the compared relative motion characteristic data AND1.

In detail, the AND operation is performed on the element values H[0,1] to H[0,Q] of the relative motion characteristic data H[0] of the current frame M0 and inversed element values U̅[̅1̅]̅ to U̅[̅Q̅]̅ corresponding to the same row/column in the second accumulated relative motion characteristic data OR2 to obtain the compared relative motion characteristic data AND1. Therefore, the compared relative motion characteristic data AND1 includes a plurality of element values A[1] to A[Q], and the element values A[1] to A[Q] are obtained according to a following equation (9):

$$A ( q ) = H [ 0 , q ] ⋀ ( \overline{U [ q ]} ) \qquad ( 9 )$$

Where, 1≦q≦Q.

It should be noticed that as shown in FIG. 6B, the logic circuit 220 compares the relative motion characteristic data (H_{X}[0], H_{Y}[0]) of the current frame M0 with the second accumulated relative motion characteristic data (OR2_{X}, OR2_{Y}) to obtain the compared relative motion characteristic data (AND1_{X}, AND1_{Y}), where AND1_{X} represents a horizontal component of the compared relative motion characteristic data, and AND1_{Y} represents a vertical component of the compared relative motion characteristic data. Similarly, the compared relative motion characteristic data (AND1_{X}, AND1_{Y}) includes a plurality of element values A_{X}[1] to A_{X}[M] and A_{Y}[1] to A_{Y}[N], which are, for example, obtained according to following equations (9-1) and (9-2):

$$\begin{matrix}{A}_{X} [ j ] = {H}_{X} [ 0 , j ] ⋀ ( \overline{{U}_{X} [ j ]} ) & ( 9 - 1 ) \\ {A}_{Y} [ k ] = {H}_{Y} [ 0 , k ] ⋀ ( \overline{{U}_{Y} [ k ]} ) & ( 9 - 2 )\end{matrix}$$

Where, 1≦j≦M, 1≦k≦N.

Moreover, it should be noticed that the compared relative motion characteristic data AND1 is used to determine a difference degree between the current frame M0 and the other previous frames. If the second difference degree is relatively great, it represents that the moving object in the frame has a certain spatial displacement within a certain time. Therefore, in the other embodiments, other methods can be used to calculate the compared relative motion characteristic data AND1 to represent the difference, which are not limited to the method introduced in the aforementioned embodiment.

Finally, the steps S215 and S216 of FIG. 2C are executed, by which the logic circuit 220 calculates a gain value G according to the first accumulated relative motion characteristic data OR1 or (OR1_{X}, OR1_{Y}) and the compared relative motion characteristic data AND1 or (AND1_{X}, AND1_{Y}), and adjusts original moving depths corresponding to the local units 410 in the current frame M0 according to the gain value G.

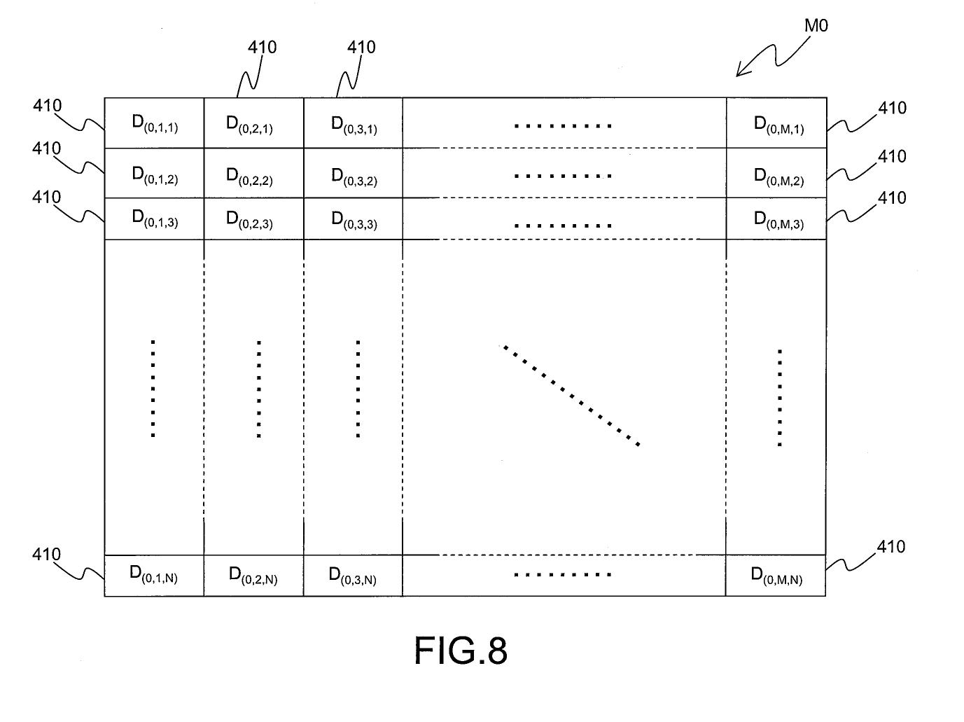

Referring to FIG. 8, FIG. 8 illustrates original moving depths corresponding to the local units 410 of the current frame M0. For simplicity's sake, an original moving depth corresponding to the local unit 410 of the j^{th} column and the k^{th} row in the frame Mi at the time point Ti is represented by D_{(i,j,k)}, where 0≦i, 1≦j≦M, 1≦K≦N. As shown in FIG. 8, the original moving depths corresponding to the local units 410 in the current frame M0 that are calculated by the logic circuit 220 are respectively represented by D_{(0,1,1)} to D_{(0,M,N)}. It is assumed that that gain value calculated by the logic circuit 220 is G, the adjusted moving depth corresponding to the local unit 410 of the j^{th} column and the k^{th} row in the frame Mi at the time point Ti is then equal to (D_{(i,j,k)}×G).

In the process of calculating the gain value G (the step S215), in a preferred embodiment, the logic circuit 220 obtains a first gain value Gain1 according to the first accumulated relative motion characteristic data OR1, and obtains a second gain value Gain2 according to the compared relative motion characteristic data AND1. Preferably, each of the first gain value Gain1 and the second gain value Gain2 can be calculated according to the first and the second directions (for example, a row direction or a column direction. Then, the logic circuit 220 calculates the gain value according to the first gain value Gain1 and the second gain value Gain2. The above process is described in detail below.

In an embodiment of the invention, the logic circuit 220 sums the element values O[1] to O[Q] of the first accumulated relative motion characteristic data OR1 to obtain a first summation Or_C, where the first summation Or_C is obtained according to a following equation (10):

$$Or\_C = {\sum }_{n = 1}^{Q} O [ n ] \qquad ( 10 )$$

Then, the logic circuit 220 obtains the first gain value Gain1 according to the first summation Or_C. In an embodiment of the invention, the logic circuit 220 obtains the first gain value Gain1 from a first gain curve C1 according to the first summation Or_C.

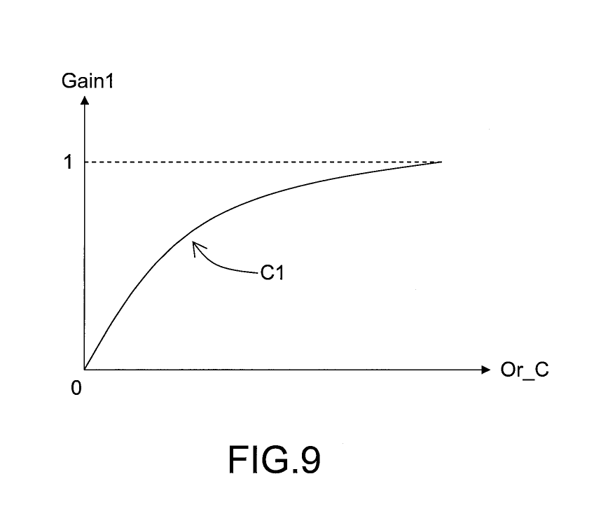

FIG. 9 illustrates the first gain curve C1 according to an embodiment of the invention. As shown in FIG. 9, the first gain curve C1 is an increasing curve, so that a larger first summation Or_C corresponds to a larger first gain value Gain1. It should be noticed that the first summation Or_C (or the first accumulated relative motion characteristic data OR1) can be used to determine an overall difference degree between the local motion vectors and the global motion vector of a plurality of continuous frames. When the difference degrees between the local motion vectors and the global motion vector in the several frames are relatively high, it represents that a moving object with a certain size probably exists in the frames, and the calculated first summation Or_C is relatively large.

Similarly, in a process of obtaining the second gain value Gain2, the logic circuit 220 first sums the element values A[1] to A[Q] of the compared relative motion characteristic data AND1 to obtain a second summation And_C, where the second summation And_C is obtained according to a following equation (11):

$$And\_C = {\sum }_{n = 1}^{Q} A [ n ] \qquad ( 11 )$$

Then, the logic circuit 220 obtains the second gain value Gain2 according to the second summation And_C. In an embodiment of the invention, the logic circuit 220 obtains the second gain value Gain2 from a second gain curve C2 according to the second summation And_C.

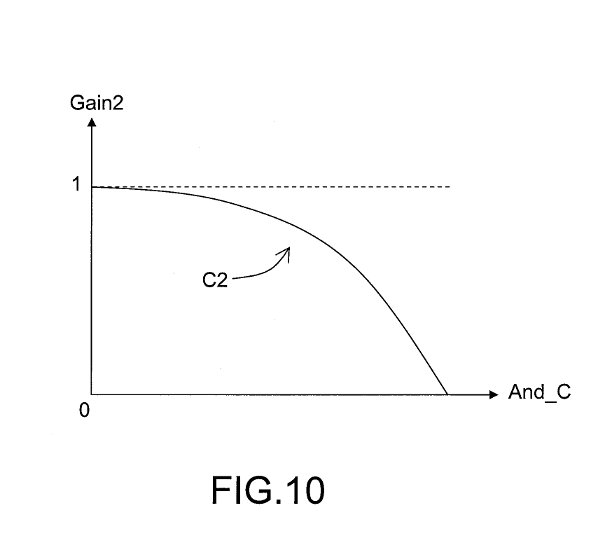

FIG. 10 illustrates the second gain curve C2 according to an embodiment of the invention. As shown in FIG. 10, the second gain curve C2 is an decreasing curve, so that a larger second summation And_C corresponds to a smaller second gain value Gain2. The second summation And_C (or the compared relative motion characteristic data AND1) can be used to determine a difference degree between the current frame M0 and the other previous frames. When the difference degree between the current frame M0 and the other previous frames is relatively high, it represents that the moving object in the frame probably has a certain spatial displacement within a certain time, and the calculated second summation And_C is relatively large.

Therefore, if the moving object in the frame is a windowed-moving object, the calculated first summation Or_C is greater, and the calculated second summation

And_C is smaller, so that a smaller gain value G is obtained. In this way, when the moving object in the frame is the windowed-moving object, the moving depth adjusted according to the smaller gain value G is relatively small, so that the depth inversion phenomenon is avoided or mitigated.

Comparatively, if the moving object in the frame is not the windowed-moving object, the calculated first summation Or_C and the second summation And_C are greater, so that a greater gain value is generated. In this way, when the moving object in the frame is not the windowed-moving object, the adjusted moving depth is greater due to the greater gain value G, and the user may view an image with a normal depth.

Then, the logic circuit 220 calculates the gain value G according to the first gain value Gain1 and the second gain value Gain2. In an embodiment of the invention, the gain value G is obtained according to a following equation (12):

G=1−Gain1×Gain2 (12)

Where, since 0≦Gain11≦1 and 0≦Gain2≦1, 0≦G≦1.

It should be noticed that the first summation, the second summation, the first gain value and the second gain value can also be calculated along two directions. In an embodiment of the invention, the logic circuit 220 sums the element values O_{X}[1] to O_{X}[M] of the horizontal component in the first accumulated relative motion characteristic data (OR1_{X}, OR1_{Y}) to obtain a horizontal component Or_C_{X} of the first summation, and sums the element values O_{Y}[1] to O_{Y}[N] of the vertical component to obtain a vertical component Or_C_{Y} of the first summation. The horizontal component Or_C_{X} and the vertical component Or_C_{Y} of the first summation can be respectively obtained according to following equations (10-1) and (10-2):

$$\begin{matrix}{Or\_C}_{X} = {\sum }_{j = 1}^{M} {O}_{X} [ j ] & ( 10 - 1 ) \\ {Or\_C}_{Y} = {\sum }_{k = 1}^{N} {O}_{Y} [ k ] & ( 10 - 2 )\end{matrix}$$

Then, the logic circuit 220 obtains a horizontal component Gain1_{X} of the first gain value according to the horizontal component Or_C_{X} of the first summation, and obtains a vertical component Gain1_{Y} of the first gain value according to the vertical component Or_C_{Y} of the first summation. The greater the horizontal component Or_C_{X} of the first summation is, the greater the horizontal component Gain1_{X} of the first gain value is, and the greater the vertical component Or_C_{Y} of the first summation is, the greater the vertical component Gain1_{Y} of the first gain value is. In an exemplary embodiment, the horizontal component Gain1_{X} and the vertical component Gain1_{Y} of the first gain value can be obtained according to the first gain curve C1 of FIG. 9. During a process of obtaining the horizontal component Gain1_{X} of the first gain value, the logic circuit 220 respectively regards a horizontal axis and a vertical axis of FIG. 9 as the horizontal component Or_C_{X} of the first summation and the horizontal component Gain1_{X} of the first gain value, and obtains the horizontal component Gain1_{X} of the corresponding first gain value from the first gain curve C1 according to the horizontal component Or_C_{X} of the first summation. Similarly, during a process of obtaining the vertical component Gain1_{Y} of the first gain value, the logic circuit 220 respectively regards the horizontal axis and the vertical axis of FIG. 9 as the vertical component Or_C_{Y} of the first summation and the vertical component Gain1_{Y} of the first gain value, and obtains the vertical component Gain1_{Y} of the corresponding first gain value from the first gain curve C1 according to the vertical component Or_C_{Y} of the first summation.

Similarly, the logic circuit 220 sums the element values A_{X}[1] to A_{X}[M] of the horizontal component of the compared relative motion characteristic data (AND1_{X}, AND1_{Y}) to obtain a horizontal component And_C_{X} of the second summation, and sums the element values A_{Y}[1] to A_{Y}[N] of the vertical component to obtain a vertical component And_C_{Y} of the second summation. The horizontal component And_C_{X} and the vertical component And_Cy of the second summation can be respectively obtained according to following equations (11-1) and (11-2):

$$\begin{matrix}{And\_C}_{X} = {\sum }_{j = 1}^{M} {A}_{X} [ j ] & ( 11 - 1 ) \\ {And\_C}_{Y} = {\sum }_{k = 1}^{N} {A}_{Y} [ k ] & ( 11 - 2 )\end{matrix}$$

Then, the logic circuit 220 obtains a horizontal component Gain2_{X} of the second gain value according to the horizontal component And_C_{X} of the second summation, and obtains a vertical component Gain2_{Y} of the second gain value according to the vertical component And_C_{Y} of the second summation. The greater the horizontal component And_C_{X} of the second summation is, the smaller the horizontal component Gain2_{X} of the second gain value is, and the greater the vertical component And_C_{Y} of the second summation is, the smaller the vertical component Gain2_{Y} of the second gain value is. In an exemplary embodiment, the horizontal component Gain2_{X} and the vertical component Gain2_{Y} of the second gain value can be obtained according to the second gain curve C2 of FIG. 10. During a process of obtaining the horizontal component Gain2_{X} of the second gain value, the logic circuit 220 respectively regards a horizontal axis and a vertical axis of FIG. 10 as the horizontal component And_C_{X} of the second summation and the horizontal component Gain2_{X} of the second gain value, and obtains the horizontal component Gain2_{X} of the corresponding second gain value from the second gain curve C2 according to the horizontal component And_C_{X} of the second summation. Similarly, during a process of obtaining the vertical component Gain2_{Y} of the second gain value, the logic circuit 220 respectively regards the horizontal axis and the vertical axis of FIG. 10 as the vertical component And_C_{Y} of the second summation and the vertical component Gain2_{Y} of the second gain value, and obtains the vertical component Gain2_{Y} of the corresponding second gain value from the second gain curve C2 according to the vertical component And_C_{Y} of the second summation.

Then, the logic circuit 220 calculates the gain value G according to the horizontal component Gain1_{X} and the vertical component Gain1_{Y} of the first gain value, and the horizontal component Gain2_{X} and the vertical component Gain2_{Y} of the second gain value. In an embodiment of the invention, the gain value G can be obtained according to a following equation (12-1):

G=1−max(Gain1_{X}×Gain2_{X},Gain1_{Y}×Gain2_{Y}) (12-1)

According to the above equation, if (Gain1_{X}×Gain2_{X}) is greater than (Gain1_{Y}×Gain2_{Y}), the gain value G is equal to [1−(Gain1_{X}×Gain2_{X})], and if (Gain1_{X}×Gain2_{X}) is smaller than (Gain1_{Y}×Gain2_{Y}), the gain value is equal to [1−(Gain1_{Y}×Gain2_{Y})], where since Gain1 [symbol] , Gain1 [symbol] , Gain2 [symbol] , Gain2_{Y} are all greater than or equal to 0 and are smaller than or equal to 1, 0≦G≦1.

In summary, the gain value can be obtained according to the first accumulated relative motion characteristic data and the compared relative motion characteristic data. The first accumulated relative motion characteristic data can be obtained by determining an overall difference degree between the local motion vectors and the global motion vector of several frames, and the compared relative motion characteristic data can be obtained by determining a difference degree of the current frame and the other previous frames. Therefore, the obtained gain value can be related to the difference degree between the local motion vectors and the global motion vector and the difference degree between the current frame and the other previous frames. In this way, the moving depth of the current frame adjusted according to the gain value can more truly reflect a photographing situation, so as to avoid or mitigate the depth inversion phenomenon.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for adjusting moving depths for a video, adapted for two-dimensional to three-dimensional conversion, and comprising:
(i) receiving a plurality of frames at a plurality time points, and calculating relative motion characteristic data of each of the frames according to a plurality of local motion vectors and a global motion vector of each of the frames;
(ii) accumulating the relative motion characteristic data of the frames to obtain first accumulated relative motion characteristic data;
(iii) accumulating the relative motion characteristic data of the frames except a current frame to obtain second accumulated relative motion characteristic data;
(iv) comparing the relative motion characteristic data of the current frame and the second accumulated relative motion characteristic data to obtain compared relative motion characteristic data;
(v) calculating a gain value according to the first accumulated relative motion characteristic data and the compared relative motion characteristic data; and
(vi) adjusting original moving depths of the current frame according to the gain value.

2. The method for adjusting moving depths for the video as claimed in claim 1, wherein the step (i) comprises:
(a) calculating differences of the local motion vectors and the global motion vector of each of the frames to obtain a plurality of relative motion vectors; and
(b) obtaining the relative motion characteristic data of each of the frames according to the local motion vectors and the relative motion vectors of each of the frames.

3. The method for adjusting moving depths for the video as claimed in claim 2, wherein the step (b) comprises:
(b1) determining whether an absolute value of each of the local motion vectors is greater than a first threshold;
(b2) determining whether an absolute value of each of the relative motion vectors is greater than a second threshold; and
(b3) obtaining the relative motion characteristic data of each of the frames according to above determination results.

4. The method for adjusting moving depths for the video as claimed in claim 3, wherein the step (b3) comprises:
calculating a plurality of comparison result values corresponding to a plurality of local units in each of the frames according to the determination results; and
mapping the comparison result values along a row/column direction to generate a mapping motion vector, wherein the mapping motion vector represents the relative motion characteristic data.

5. The method for adjusting moving depths for the video as claimed in claim 4, wherein the step of generating the mapping motion vector comprises:
counting the comparison result values along the row/column direction to generate a plurality of counting values corresponding to different rows/columns; and
respectively comparing the counting values to a third threshold, and generating a plurality of element values of the mapping motion vector according to comparison results of the counting values and the third threshold.

6. The method for adjusting moving depths for the video as claimed in claim 1, wherein the steps (i) to (v) are respectively implemented according to one to a plurality of directions of the frames.

7. The method for adjusting moving depths for the video as claimed in claim 1, wherein the relative motion characteristic data of each of the frames comprises a plurality of element values corresponding to different rows/columns, and the step (ii) comprises:
performing an OR operation on the element values corresponding to a same row/column in the frames to obtain the first accumulated relative motion characteristic data.

8. The method for adjusting moving depths for the video as claimed in claim 7, wherein the step (iii) comprises:
performing an OR operation on the element values corresponding to a same row/column in the relative motion characteristic data of the other frames to obtain the second accumulated relative motion characteristic data.

9. The method for adjusting moving depths for the video as claimed in claim 7, wherein the step (iv) comprises:
performing an AND operation on a plurality of element values of the relative motion characteristic data and inversed element values corresponding to a same row/column in the second accumulated relative motion characteristic data, so as to obtain the compared relative motion characteristic data.

10. The method for adjusting moving depths for the video as claimed in claim 1, wherein the step (v) comprises:
obtaining a first gain value according to the first accumulated relative motion characteristic data;
obtaining a second gain value according to the compared relative motion characteristic data; and
calculating the gain value according to the first gain value and the second gain value.

11. The method for adjusting moving depths for the video as claimed in claim 10, wherein
the step of obtaining the first gain value comprises:
obtaining the first gain value from a first gain curve according to a first summation of a plurality of element values of the first accumulated relative motion characteristic data, and
the step of obtaining the second gain value comprises:
obtaining the second gain value from a second gain curve according to a second summation of a plurality of element values of the compared relative motion characteristic data.

12. The method for adjusting moving depths for the video as claimed in claim 10, wherein each of the first gain value and the second gain value is calculated according to a first direction and a second direction.

13. The method for adjusting moving depths for the video as claimed in claim 10, wherein the step of calculating the gain value comprises:
obtaining a product of the first gain value and the second gain value along the first direction;
obtaining a product of the first gain value and the second gain value along the second direction; and
determining the gain value according to a larger one of the two products.

14. A method for adjusting moving depths for a video, adapted for two-dimensional to three-dimensional conversion, and comprising:
receiving a plurality of frames at a plurality time points, and calculating a plurality of local motion vectors and a global motion vector in each of the frames;
determining a first difference degree between the local motion vectors and the global motion vector in the frames;
determining a second difference degree between a current frame and other previous frames in the frames;
calculating a gain value according to the first difference degree and the second difference degree; and
adjusting original moving depths of the current frame according to the gain value.

15. The method for adjusting moving depths for the video as claimed in claim 14, wherein the step of determining the first difference degree comprises:
calculating differences of the local motion vectors and the global motion vectors in each of the frames to obtain a plurality of relative motion vectors;
obtaining the relative motion characteristic data of each of the frames according to the local motion vectors and the relative motion vectors of each of the frames; and
accumulating the relative motion characteristic data of the frames to obtain first accumulated relative motion characteristic data, wherein the first accumulated relative motion characteristic data represents the first difference degree.

16. The method for adjusting moving depths for the video as claimed in claim 15, wherein the step of obtaining the relative motion characteristic data of each of the frames comprises:
determining whether an absolute value of each of the local motion vectors is greater than a first threshold;
determining whether an absolute value of each of the relative motion vectors is greater than a second threshold; and
obtaining the relative motion characteristic data of each of the frames according to above determination results.

17. The method for adjusting moving depths for the video as claimed in claim 15, wherein the step of determining the second difference degree comprises:
accumulating the relative motion characteristic data of the frames except a current frame to obtain second accumulated relative motion characteristic data; and
comparing the relative motion characteristic data of the current frame and the second accumulated relative motion characteristic data to obtain compared relative motion characteristic data, wherein the compared relative motion characteristic data represents the second difference degree.

18. The method for adjusting moving depths for the video as claimed in claim 14, wherein the greater the first difference degree is, the smaller the gain value is set, and the smaller the second difference degree is, the smaller the gain value is set.
